(19) United States
(12) Patent Application Publication
(10) Pub. No.: US 2013/0233341 A1
(43) Pub. Date: Sep. 12, 2013

(54) IMAGE CAPTURING DEVICE AND VIBRATION DUST REMOVAL METHOD THEREOF

(71) Applicant: Chao-Yi LIN, Hsinchu County (TW)

(72) Inventor: Chao-Yi LIN, Hsinchu County (TW)

(21) Appl. No.: 13/477,494

(22) Filed: May 22, 2012

(30) Foreign Application Priority Data
Mar. 12, 2012 (TW) 101108333

(51) Int. Cl. H04N 5/225; B08B 7/02

(52) U.S. Cl. 134/1; 348/340; 348/E05.024

(57) ABSTRACT

This invention discloses an image capturing device and a vibration dust removal method thereof. The image capturing device comprises a power supply component, an image sensor, a vibration dust removal component, a power detection module and a controller. The vibration dust removal component produces vibrations for dust removal. The power detection module detects a power value of the power supply component, and produces an electric power signal. The controller electrically connects the vibration dust removal component and the power detection module. The controller determines a maximum value of the amplitude of a vibration produced by the vibration dust removal component according to the electric power signal to control the vibration dust removal component to execute a vibration dust removal operation of the image sensor.

### CROSS-REFERENCE TO RELATED APPLICATION

This application claims the benefit of Taiwan Patent Application No. 101108333, filed on Mar. 12, 2012, in the Taiwan Intellectual Property Office, the disclosure of which is incorporated herein in its entirety by reference.

### BACKGROUND OF THE INVENTION

1. Field of the Invention

The present invention relates to an image capturing device and a vibration dust removal method thereof, and more particularly to the image capturing device and the vibration dust removal method capable of adjusting the amplitude of a vibration dust removal operation according to a power level of the image capturing device.

2. Description of Related Art

Conventional interchangeable-lens digital cameras (such as digital single lens reflex cameras) are generally sold at a price unaffordable to most people. As science and technology advances and the arrival of the digital era, the price of the interchangeable lens cameras drops to an affordable price, so that the interchangeable digital camera becomes a common 3C product for almost everyone. The advantages of the interchangeable lens digital cameras is to provide a camera lens that can be changed appropriately by users to cope with the requirements of taking a scene or a picture. However, most interchangeable lens digital cameras have a movable connecting opening for the installation of the camera lens to the interchangeable lens digital cameras. Foreign substances such as dust and hair may enter into the interchangeable lens digital camera and adhere or attach onto the image sensor during the process of changing the camera lens. As a result, different sized gray spots will appear on the image and affect the quality of the overall image and it will considerable amount of time for users to remove the gray spots by image processing software.

At present, most dust removal methods use a vibration dust removal component to perform a vibration dust removal operation of the image sensor, and most interchangeable lens digital cameras do not have a power detection mechanism to perform vibration dust removal operation. If a user performs the vibration dust removal operation without noticing the remaining power condition, the remaining power of the interchangeable lens digital camera will be exhausted after the vibration dust removal operation is performed for some time, so that the interchangeable lens digital camera cannot take a picture as the power is exhausted, and the user may lose the opportunity of recording an important scene.

Alternatively, some interchangeable lens digital cameras are preset to perform a vibration dust removal operation during a power-on process, and such vibration dust removal mechanism may cause a failure of taking a picture by the interchangeable lens digital cameras after the vibration dust removal operation of the interchangeable lens digital cameras takes place due to insufficient remaining power, and thus causing tremendous inconvenience to users.

Therefore, the inventor of the present invention designs an image capturing device and a vibration dust removal method to overcome the shortcomings of the prior art.

### SUMMARY OF THE INVENTION

In view of the aforementioned problems of the prior art, it is a primary objective of the invention to provide an image capturing device and a vibration dust removal method thereof to overcome the problem of failing capture an image after a conventional vibration dust removal operation takes place.

To achieve the foregoing objective, the present invention provides an image capturing device comprising an image sensor, a power supply component, a vibration dust removal component, a power detection module and a controller. The image sensor receives an optical signal and converts the optical signal into an image signal. The vibration dust removal component produces a vibration to perform a dust removal operation of an image sensor. The power detection module detects an electric power value of the power supply component and generates an electric power signal. The controller is electrically coupled to the image sensor, the vibration dust removal component and the power detection module. The controller determines a maximum amplitude of a vibration produced by the vibration dust removal component to control the vibration dust removal component to perform a dust removal operation for the image sensor according to the maximum amplitude of the vibration.

Wherein, the controller increases the amplitude of the vibration gradually from low to high, until the amplitude reaches the maximum amplitude, or the controller controls the vibration dust removal component to directly produce the vibration with the maximum value.

Wherein, the image capturing device further comprises a detector for detecting whether a replaceable optical component is connected to the image capturing device, if the replaceable optical component is not connected to the image capturing device, the controller determines to drive the image capturing device to perform the vibration dust removal operation.

Wherein, the image capturing device further comprises a vibration trigger module, wherein the controller controls the vibration dust removal component to perform the vibration dust removal operation according to a control signal generated by the vibration trigger module when the detector detects the replaceable optical component not being connected.

Wherein, the controller controls the vibration dust removal component to stop producing the vibration when the controller controls the vibration dust removal component to produce the vibration for a predetermined time.

Wherein, the controller compares the electric power signal with a predetermined power value; if the electric power signal is smaller than the predetermined power value, then the vibration dust removal component is controlled to stop producing the vibration.

To achieve the aforementioned objective, the present invention further provides a vibration dust removal method applied in an image capturing device, and the vibration dust removal method comprising the steps of: using a power detection module to detect an electric power value of the image capturing device and generate an electric power signal; and determine a maximum amplitude of a vibration produced by the vibration dust removal component according to the electric power signal, performing a vibration dust removal operation of an image sensor of the image capturing device according to the maximum amplitude.

Wherein, the controller increases the amplitude of the vibration gradually from low to high, until the vibration reaches the maximum amplitude, or the controller directly uses the maximum amplitude to control the vibration dust removal component to produce the vibration.

Wherein, the method further comprises the steps of using a detector to determine whether a replaceable optical component is connected to the image capturing device; and driving the image capturing device by the controller to perform the vibration dust removal operation if the detector determines that the replaceable optical component is not connected to the image capturing device.

Wherein, the method further comprises the following steps: Using a vibration trigger module to output a control signal to the controller if the detector determines that the replaceable optical component is connected to the image capturing device; using the controller drive the vibration dust removal component to perform the vibration dust removal operation according to the control signal.

Wherein, the vibration dust removal method further comprises the step of controlling the vibration dust removal component to produce a vibration for a predetermined time, and then controlling the vibration dust removal component to stop producing the vibration.

Wherein, the vibration dust removal method further comprises the step of comparing the electric power signal with a predetermined power value; and controlling the vibration dust removal component to stop producing the vibration if the electric power signal is smaller than the predetermined power value.

In summation, the image capturing device and the vibration dust removal method thereof in accordance with the present invention have one or more of the following advantages:

(1) The image capturing device and the vibration dust removal method of the present invention can detect the electric power value of the power supply component by the power detection module to determine whether or not to perform the vibration dust removal operation, so as to overcome the problem of having insufficient power after performing the vibration dust removal operation.

(2) The image capturing device and the vibration dust removal method of the invention can detect the electric power value of the power supply component by the power detection module during the power-on process to determine whether to perform the vibration dust removal operation during the power-on process, so as to reduce the chance of failing to take a picture after performing the vibration dust removal operation during the power-on process.

(3) The image capturing device and the vibration dust removal method of the invention can use the controller to determine the maximum value of the amplitude of the vibration produced by the vibration dust removal component according to the electric power signal to perform a vibration dust removal operation, so as to avoiding expending too much power on the vibration dust removal operation.

### BRIEF DESCRIPTION OF THE DRAWINGS

FIG. 1 is a block diagram of an image capturing device of the present invention;

FIG. 2 is a block diagram of an image capturing device in accordance with a preferred embodiment of the present invention;

FIG. 3 is a first flow chart of an operation of an image capturing device in accordance with a preferred embodiment of the present invention;

FIG. 4 is a second flow chart of an operation of an image capturing device in accordance with a preferred embodiment of the present invention; and

FIG. 5 is a flow chart of a vibration dust removal method of the present invention.

### DETAILED DESCRIPTION OF THE PREFERRED EMBODIMENTS

The technical contents and characteristics of the present invention will be apparent with the detailed description of a preferred embodiment accompanied with related drawings as follows. For simplicity, same numerals are used in the following preferred embodiment to represent respective same elements.

The image capturing device of the present invention can be an interchangeable-lens camera or a digital single lens reflex camera. To facilitate the description of the technical characteristics of the present invention, the interchangeable-lens camera is used as an example in the following preferred embodiments, but the invention is not limited to the interchangeable-lens camera only.

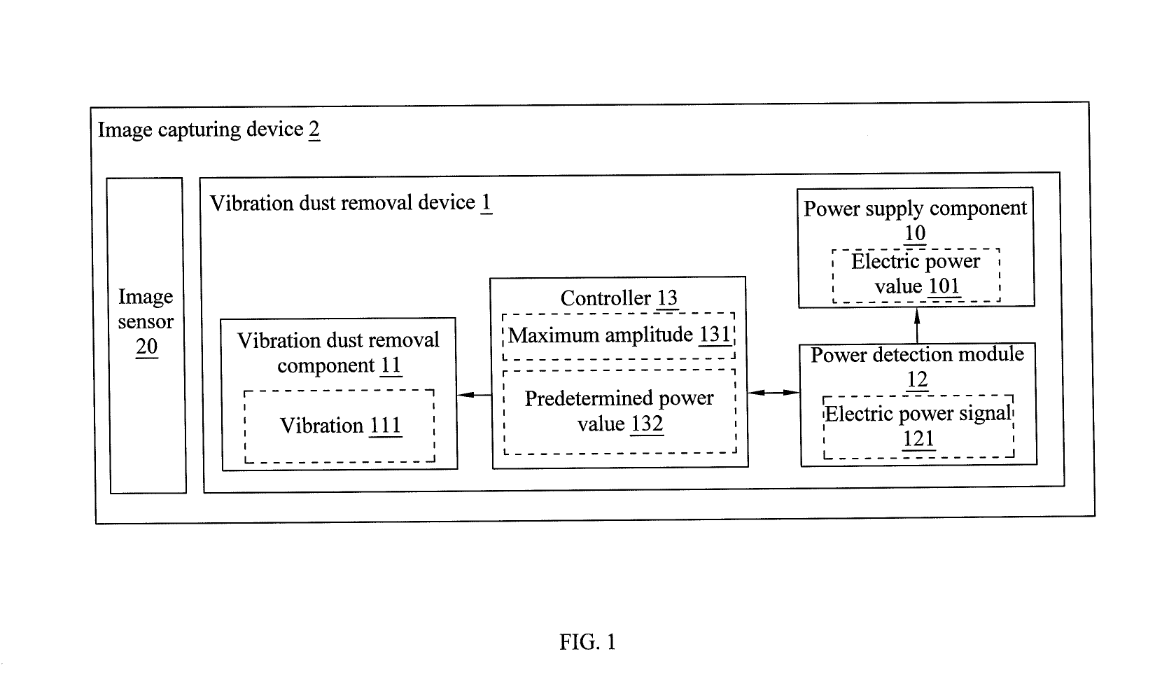

With reference to FIG. 1 for a block diagram of an image capturing device of the present invention, the image capturing device 2 has a vibration dust removal device 1 comprising: a power supply component 10, a vibration dust removal component 11, a power detection module 12 and a controller 13. Wherein, the power supply component 10 can be a rechargeable or regular battery such as a nickel-cadmium battery, a nickel-hydrogen battery, a zinc-manganese battery, an alkaline manganese battery or a lithium battery. The vibration dust removal component 11 produces a vibration 111 to perform the dust removal operation. The power detection module 12 detects an electric power value 101 of the power supply component 10 and generates an electric power signal 121. The controller 13 is electrically coupled to the vibration dust removal component 11 and the power detection module 12, and can be a central processing unit (CPU) or a micro processing unit. The controller 13 determines a maximum amplitude 131 of the vibration produced by the vibration dust removal component 11 according to the electric power signal 121, so as to control the vibration dust removal component 11 to perform the vibration dust removal operation to an image sensor 20 of the image capturing device 2.

More specifically, when a user turns on the image capturing device or controls the image capturing device to perform the vibration dust removal operation, the power detection module 12 detects the electric power value 101 of the power supply component 10 and generates the electric power signal 121 according to the electric power value 101 and transmits the electric power signal 121 to the controller 13. The controller 13 compares the electric power signal 121 with a predetermined power value 132. If the controller 13 determines that the electric power signal 121 is smaller than a predetermined power value 132, then the vibration dust removal operation will not be performed. On the other hand, if the controller 13 determines that the electric power signal 121 is greater than the predetermined power value 132, the controller 13 will determine the maximum amplitude 131 of the vibration produced by the vibration dust removal component 11 according to the electric power signal 121, so as to control the vibration dust removal component 11 to perform the vibration dust removal operation to an image sensor 20. It is noteworthy to point out that when the controller 13 determines a maximum amplitude 131 of the vibration produced by the vibration dust removal component 11 and controls the vibration dust removal component 11 to increase the amplitude of the vibration from low to high up to the maximum amplitude 131, or controls the vibration dust removal component 11 to perform the vibration dust removal operation directly by the maximum amplitude 131.

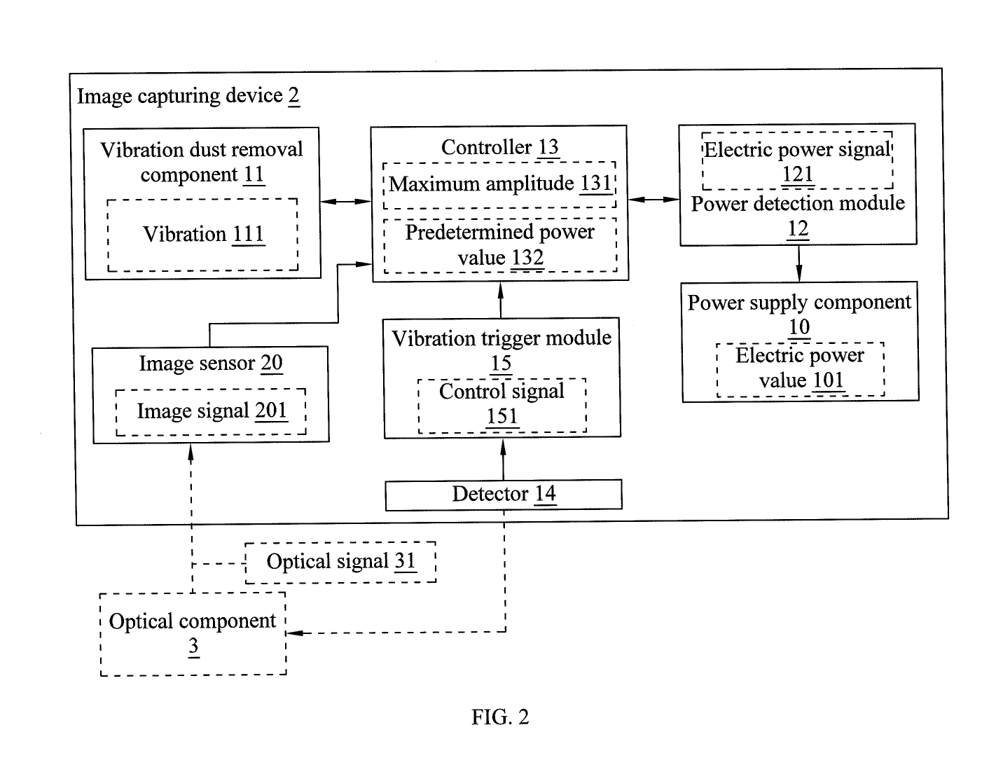

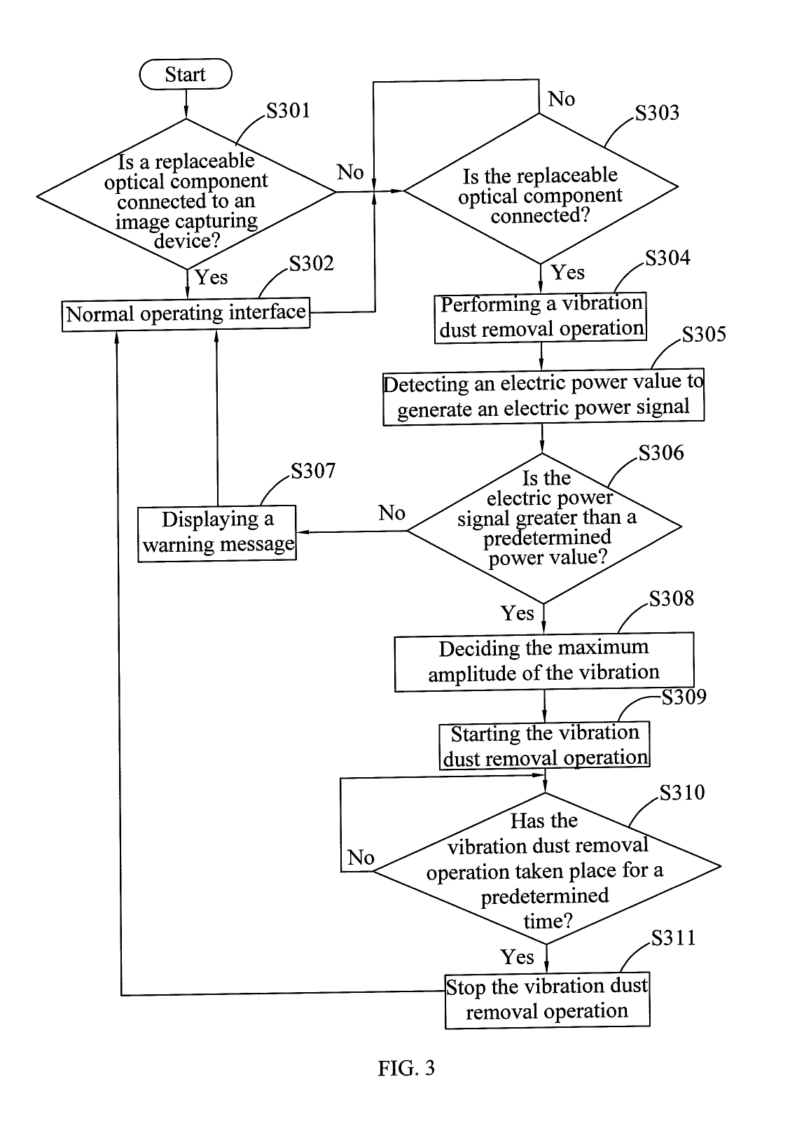

With reference to FIGS. 2 and 3 for a block diagram of an image capturing device and a first flow chart of an operation of the image capturing device in accordance with a preferred embodiment of the present invention respectively, this preferred embodiment is similar to the previous preferred embodiment, and the similar parts will not be repeated. In the figures, the image capturing device 2 of the present invention can be an interchangeable-lens camera or a digital single lens reflex camera, comprising: an image sensor 20, a power supply component 10, a vibration dust removal component 11, a power detection module 12, a controller 13, a detector 14 and a vibration trigger module 15. The image sensor 20 receives an optical signal 31 from a replaceable optical component 3 and converts the optical signal 31 into an image signal 201, and the image sensor 20 can be a complementary metal oxide semiconductor (CMOS) or charge coupled device (CCD), an analog/digital circuit, or an image processor. The detector 14 detects whether the replaceable optical component 3 is connected to the image capturing device 2. The vibration trigger module 15 is electrically coupled to the detector 14. If the detector 14 detects that the replaceable optical component 3 is not connected, the controller 13 will drive vibration dust removal component 11 to perform the vibration dust removal operation according to a control signal 151 generated by the vibration trigger module 15. Wherein, the replaceable optical device 3 can be an interchangeable-lens camera such as a digital single lens reflex (DSLR) camera.

When a user presses a power button (not shown in the figure) of the image capturing device 2 to turn on the image capturing device 2, the detector 14 detects whether the replaceable optical component 3 is connected to the image capturing device 2 (as indicated by the step S301 in FIG. 3). If yes, then the controller 13 will drive the image capturing device 2 to perform a normal operation such as taking a picture, browsing an image or editing an image (as indicated by the step S302 in FIG. 3). If no, then the detector 14 will continue the detection until the replaceable optical component 3 is connected to the image capturing device 2 (as indicated by the step S303 in FIG. 3). If the replaceable optical component 3 is connected to the image capturing device 2, the vibration trigger generating module 15 will generate a control signal 151, such that the controller 13 decides to drive the image capturing device 2 to perform the vibration dust removal operation according to the control signal 151 (as indicated by the step S304 in FIG. 3). Now, the power detection module 12 detects an electric power value 101 of the power supply component 10 of the image capturing device 2, and generates and transmits an electric power signal 121 to the controller 13 (as indicated by the step S305 in FIG. 3). The controller 13 compares the electric power signal 121 with a predetermined power value 132 (as indicated by the step S306 in FIG. 3); if the electric power signal 121 is smaller than the predetermined power value 132, then the controller 13 will control image capturing device 2 to display a warning message on a display unit (not shown in the figure) (as indicated by the step S307 in FIG. 3); and if the electric power signal 121 is greater than the predetermined power value 132, the controller 13 will decide to let the image capturing device 2 continue to perform the vibration dust removal operation. If the controller 13 decides to let the image capturing device 2 continue to perform the vibration dust removal operation, the controller 13 will determine a maximum amplitude 131 of the vibration 111 produced by the vibration dust removal component 11 according to the electric power signal 121 (as indicated by the step S308 in FIG. 3) to control the vibration dust removal component 11 to drive the image sensor 20 to perform the dust removal operation (as indicated by the step S309 in FIG. 3). When the vibration dust removal component 11 performs the dust removal operation to the image sensor 20, the controller 13 determines whether or not to produce the vibration 111 for a predetermined time (as indicated by the step S310 in FIG. 3); if no, then the controller 13 will control the vibration dust removal component 11 to continue performing the dust removal operation to the image sensor 20. After the controller 13 controls the vibration dust removal component 11 to produce the vibration 111 for a predetermined time, the controller 13 will control the vibration dust removal component 11 to stop producing the vibration 111 (as indicated by the step S311 in FIG. 3). It is noteworthy to point out that the image capturing device 2 will perform the dust removal operation during a power-on process, and the image capturing device 2 can set the controller 13 to control the vibration dust removal component 11 to increase the amplitude of the vibration gradually from low to high up to a maximum amplitude 131. Therefore, the vibration dust removal operation can be performed after the replaceable optical component 3 of the image capturing device 2 is replaced in order to avoid performing the dust removal operation at the maximum amplitude 131, when the dust is adhered on the image sensor 20. Users can change the setting to the maximum value as needed. However, the invention is not limited to any particular setting. In addition, the detector 14 still continues the detection to detect whether the replaceable optical component 3 is connected to or removed from the image capturing device 2 in a power-on during a normal operation, so as to facilitate performing the vibration dust removal operation.

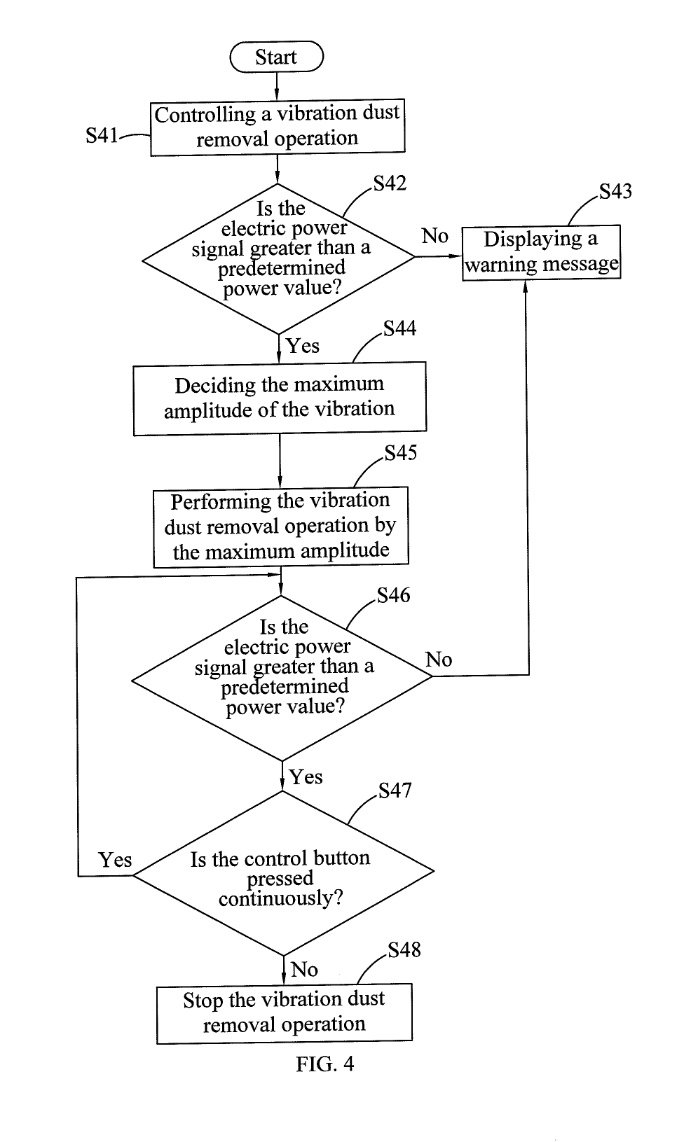

With reference to FIG. 4 for a second flow chart of an operation of an image capturing device in accordance with a preferred embodiment of the present invention, if a user presses a control button (not shown in the figure) to control the image capturing device 2 to perform the vibration dust removal operation during a normal operation (as indicated by the step S41 in FIG. 4), the controller 13 will confirm whether there is sufficient power to perform the dust removal operation. Similarly, the controller 13 compares the electric power signal 121 with the predetermined power value 132 (as indicated by the step S42 in FIG. 4). If there is insufficient power to perform the dust removal operation, then a warning message will be displayed to inform the user (as indicated by the step S43 in FIG. 4). If there is sufficient power to perform the dust removal operation, then the controller 13 will determine the maximum amplitude 131 of the vibration according to the electric power signal 121 of the power detection module 12 (as indicated by the step S44 in FIG. 4) and will directly use the maximum amplitude 131 to control the vibration dust removal component 11 to perform the dust removal operation (as indicated by the step S45 in FIG. 4). Similarly, the users can set or change the vibration dust removal operation as described above.

While the vibration dust removal component 11 performs the vibration dust removal operation to image sensor 20, the power detection module 12 continues detecting the power supply component 10 to generate an electric power signal 121, and the controller 13 continues comparing the electric power signal 121 with the predetermined power value 132 (as indicated by the step S46 in FIG. 4) to prevent the situation of failing to take picture due to insufficient power after the vibration dust removal operation takes place and there is no power supply available for charging. In addition, the controller 13 will continue confirming whether the control button is pressed (as indicated by the step S47 in FIG. 4). If the user no longer presses the control button, the controller 13 will control the vibration dust removal component 11 to stop the vibration dust removal operation (as indicated by the step S48 in FIG. 4). Wherein, the control button can be one of a plurality of physical press buttons installed on the image capturing device 2, or a virtual button shown on a touch screen and provided for the user to touch. However, the invention is not limited to any particular type of buttons. It is noteworthy to point out that a restrictive condition can be added between the step S47 and the step S48. The restrictive condition refers to a condition for the controller 13 to control the vibration dust removal component 11 to produce a vibration 111 for a predetermined time, or a condition for the controller 13 to control the vibration dust removal component 11 to stop producing the vibration 111. In other words, if the vibration dust removal operation has been continued for a certain time and the dust attached onto the image sensor 20 has not been removed, it means that the adhesive force of the dust is strong, so that it is necessary to spend more electric power of the image capturing device 2 to perform the vibration dust removal operation in order to remove the dust.

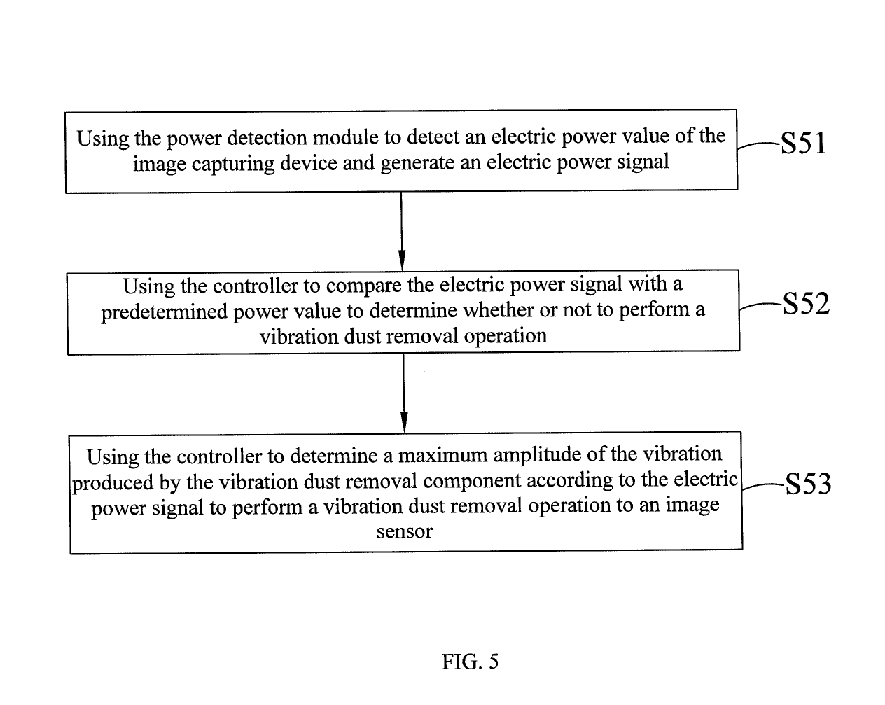

With reference to FIG. 5 for a flow chart of a vibration dust removal method of the present invention, the vibration dust removal method is applied in an image capturing device which can be an interchangeable-lens image capturing device. The image capturing device comprises an image sensor, a power supply component, a vibration dust removal component, a power detection module and a controller. The vibration dust removal method comprises the following steps:

S51: Using the power detection module to detect an electric power value of the image capturing device and generate an electric power signal.

S52: Using the controller to compare the electric power signal with a predetermined power value to determine whether or not to perform a vibration dust removal operation.

S53: Using the controller to determine a maximum value of the amplitude of the vibration produced by the vibration dust removal component according to the electric power signal to perform a vibration dust removal operation to an image sensor.

The details and implementation of a vibration dust removal method of an image capturing device of the present invention have been described in the section of the image capturing device already, and thus will not be repeated.

In summation of the description above, the image capturing device and the vibration dust removal method of the present invention can generate an electric power signal provided for the controller to compare when the power detection module starts the vibration dust removal operation or when the power supply component detects the electric power value during the vibration dust removal operation. This method can avoid the situation of failing to take a picture due to insufficient power after the vibration dust removal operation takes place. In addition, the controller determines the maximum value of the amplitude of the vibration produced by the vibration dust removal component according to the electric power signal to execute a vibration dust removal operation, and this method can provide the maximum vibration whenever the power allows to perform the dust removal operation effectively and also prevent expending too much battery power for the vibration dust removal operation.

What is claimed is:

1. An image capturing device, comprising:
a power supply component;
an image sensor, for receiving an optical signal, and converting the optical signal into an image signal;
a vibration dust removal component, for producing a vibration to perform a dust removal operation for the image sensor;
a power detection module, for detecting an electric power value of the power supply component to generate an electric power signal; and
a controller, electrically coupled to the image sensor, the vibration dust removal component and the power detection module, for determining a maximum amplitude of the vibration produced by the vibration dust removal component to control the vibration dust removal component to perform the dust removal operation for the image sensor according to the maximum amplitude of the vibration.

2. The image capturing device of claim 1, wherein the controller increases the amplitude of the vibration gradually from low to high, until the amplitude reaches the maximum amplitude, or the controller controls the vibration dust removal component to directly produce the vibration with the maximum value.

3. The image capturing device of claim 1, further comprising a detector for detecting whether a replaceable optical component is connected to the image capturing device, if the replaceable optical component is not connected to the image capturing device, the controller determines to drive the image capturing device to perform the vibration dust removal operation.

4. The image capturing device of claim 3, further comprising a vibration trigger module, wherein the controller controls the vibration dust removal component to perform the vibration dust removal operation according to a control signal generated by the vibration trigger module when the detector detects the replaceable optical component not being connected.

5. The image capturing device of claim 1, wherein the controller controls the vibration dust removal component to stop producing the vibration when the controller controls the vibration dust removal component to produce the vibration for a predetermined time.

6. The image capturing device of claim 1, wherein the controller compares the electric power signal with a predetermined power value; if the electric power signal is smaller than the predetermined power value, then the vibration dust removal component is controlled to stop producing the vibration.

7. A vibration dust removal method, applied in an image capturing device, and the vibration dust removal method comprising the steps of:
using a power detection module to detect an electric power value of the image capturing device and generate an electric power signal; and
using a controller to determine a maximum amplitude of a vibration produced by a vibration dust removal component according to the electric power signal;
performing a vibration dust removal operation of an image sensor of the image capturing device according to the maximum amplitude.

8. The vibration dust removal method of claim 7, wherein the controller increases the amplitude of the vibration gradually from low to high, until the vibration reaches the maximum amplitude, or the controller directly uses the maximum amplitude to control the vibration dust removal component to produce the vibration.

9. The vibration dust removal method of claim 7, further comprising the steps of:
using a detector to determine whether a replaceable optical component is connected to the image capturing device; and
driving the image capturing device by the controller to perform the vibration dust removal operation if the detector determines that the replaceable optical component is not connected to the image capturing device.

10. The vibration dust removal method of claim 9, further comprising the steps of:
using a vibration trigger module to output a control signal to the controller if the detector determines that the replaceable optical component is connected to the image capturing device; and
using the controller to drive the vibration dust removal component to perform the vibration dust removal operation according to the control signal.

11. The vibration dust removal method of claim 7, further comprising the step of controlling the vibration dust removal component to produce the vibration for a predetermined time, and then controlling the vibration dust removal component to stop producing the vibration.

12. The vibration dust removal method of claim 7, further comprising the step of comparing the electric power signal with a predetermined power value; and controlling the vibration dust removal component to stop producing the vibration if the electric power signal is smaller than the predetermined power value.
